(19) United States
(12) Patent Application Publication
(10) Pub. No.: US 2024/0199884 A1
(43) Pub. Date: Jun. 20, 2024

(54) PROCESS FOR MAKING A NON-FIBROUS WATER SOLUBLE PRODUCT

(71) Applicant: The Procter & Gamble Company, Cincinnati, OH (US)

(72) Inventors: Justin Thomas Cacciatore, Cincinnati, OH (US); Jordan David Wellbaum, Union, KY (US); Alexander Michael Fry, Liberty Township, OH (US); John Philip Hecht, Cincinnati, OH (US); Mark Robert Sivik, Mason, OH (US); Jeffrey Wayne Denny, Fairfield Township, OH (US)

(21) Appl. No.: 18/526,192

(22) Filed: Dec. 1, 2023

Related U.S. Application Data
(60) Provisional application No. 63/429,579, filed on Dec. 2, 2022.

(51) Int. Cl. C09B 67/02

(52) U.S. Cl. CPC C09B 67/0097

(57) ABSTRACT

A method of manufacturing a non-fibrous water soluble product comprising particles, comprising: a) providing a first continuous water soluble non-fibrous substrate comprising a first side and moving in a first direction, b) providing a discretizing unit comprising one or more pockets comprising an opening; c) providing a continuous feed of first particles to at least one of the one or more pockets of the discretizing unit through the pocket opening at least partially filling the at least one of the one or more pockets, d) delivering the first particles from the pocket through the opening onto a portion of the first side of the first continuous water soluble non-fibrous substrate, and e) at least partially covering the first side of the first continuous water soluble non-fibrous substrate.

### FIELD OF THE INVENTION

Processes for making non-fibrous water soluble products utilizing a discretizing element.

### BACKGROUND OF THE INVENTION

Non-fibrous water-soluble pouches are highly desired by consumers. These non-fibrous water-soluble product allow ease of use in that the consumer can easily and simply dose the desired number of product into their desired process. This is much easier compared to having to pour liquid or powder into a process, which can be very difficult to accurately dose the correct amount of active, and for some consumers may also be physically difficult.

The method of manufacturing non-fibrous water-soluble product is complicated with many steps being required to form the non-fibrous water-soluble product and dose the required amount of ingredients, like particles, into the non-fibrous water-soluble product in an efficient and consistent manner.

Typically, a first non-fibrous water-soluble film is formed into a cavity, into which bulk particles, such as a detergent composition, is dosed, and the cavity is sealed by a second non-fibrous water-soluble film. The process of dosing particles into the cavity can be inefficient and controlling the consistency of the chemistry that is dosed into the cavity can be challenging. This is especially problematic for those ingredients, such as enzymes, that are typically present at only very low levels in the detergent composition.

Thus, there is a continuing unmet need for a process to make non-fibrous water-soluble unit dose products with particles in an efficient manner.

### SUMMARY OF THE INVENTION

Included herein is a method of manufacturing a non-fibrous water soluble product comprising particles, comprising: a) providing a first continuous water soluble non-fibrous substrate comprising a first side and moving in a first direction, b) providing a discretizing unit comprising one or more pockets comprising an opening; c) providing a continuous feed of first particles to at least one of the one or more pockets of the discretizing unit through the pocket opening at least partially filling the at least one of the one or more pockets, d) delivering the first particles from the pocket through the opening onto a portion of the first side of the first continuous water soluble non-fibrous substrate, and e) at least partially covering the first side of the first continuous water soluble non-fibrous substrate.

Also included herein is a method of manufacturing a non-fibrous water soluble product comprising particles, comprising: a) providing a first continuous water soluble non-fibrous substrate comprising a first side and moving in a first direction, b) providing a discretizing unit comprising one or more pockets comprising an opening; c) providing a continuous feed of first particles to at least one of the one or more pockets of the discretizing unit through the pocket opening, d) intermittently delivering the first particles from the pocket opening onto a portion of a first side of the first continuous water soluble non-fibrous substrate, e) metering the first particles to a target dose, and f) at least partially covering the first side of the first continuous water soluble non-fibrous substrate.

These and other iterations will be described more fully below.

### BRIEF DESCRIPTION OF THE DRAWINGS

FIG. 1 is a representation of a discretizing element with pockets;

FIG. 2 is a representation of a stator;

FIG. 3 is an exploded view of a discretizing element and a stator;

FIG. 4 is a representation of a combination of a stator and a hopper;

FIG. 5 is a graph showing dose time versus angle from horizontal on the stator outlet;

FIG. 6 is a cross-section view of a discretizing element and a stator; and

FIG. 7 is a time lapse of a cross-section view of a discretizing element and a stator.

### DETAILED DESCRIPTION OF THE INVENTION

Manufacturing a non-fibrous water soluble product can be a delicate balancing of materials and processing to achieve the desired end product, functionality, performance, and meet the economic requirements for mass production. Previous methods of dosing particles onto non-fibrous substrates were complicated. Despite the difficulties with known manufacturing methods, there is still a desire to be able to load larger amounts of particles, different types of particles, control where the particles are located within the non-fibrous water soluble product, and to do so in an economically feasible way. This allows for greater product flexibility. A review of possible solutions in the industry did not identify an intermittent particle applicator that could meet the base requirements of: frequency of dose, individual dose mass (mass flow), dosing footprint, and manufacturing flexibility within practical limits. For example, application of auger-based intermittent particle fillers are typically limited to an operational frequency of 3.33 doses/s—nearly half of the target starting rate of 6 doses/sec. Utilizing such a technology would require substantial capital investment to ‘number up’ units in series to attempt to hit the 6 doses/s target starting rate.

Another challenge with the addition of particles to a non-fibrous water soluble product is in the manufacturing of a non-fibrous water soluble product. For example, one way of making a non-fibrous water soluble product is with a continuous substrate. This continuous substrate, however, is being utilized to make discrete products. This means even though the substrate is continuous, the particles need to be applied intermittently to create the discrete products. To create the discrete products on the continuous substrate, the particles need to be delivered to the substrate in such a way that they stay predominantly in a defined area. Other devices which deliver particles, like rotary feeders, are generally designed for bulk flow control and not to create a uniform discretized dose. Without a controlled delivery of the particles, this can lead to variable amounts of particles from product to product or failure to deliver the particles in discrete doses to allow for the formation of a discrete product.

A further challenge in controlling the particle delivery to a substrate occurs where the substrate is moving. This requires coordination between the delivery of the particles to the substrate and the positioning of the substrate. The intermittency of the dosing is phased with the position of the yet-to-be cut non-fibrous substrate product position on the substrate. Thus, the timing of the dose and movement of the substrate need to be coordinated.

Moreover, the movement of the substrate can exacerbate attempts to deliver particles to the desired portion of the substrate as particles can roll and/or splash as they land on a moving substrate. In addition, failure to control the footprint of the particles deposited on the substrate can result in some of the particles flowing into the area used for sealing the substrate to create the non-fibrous water soluble product. While a small amount of particles in this area can be tolerated, too many particles in this area can interfere with the seal and can cause product failure or failure to form a product. Ideally these issues are controlled through manufacturing conditions without the need for the addition of corrective steps, like vacuuming to remove loose particles, to allow for the more cost effective and speedy production of the product.

When looking for a solution, the inventors were interested in finding something that could be adapted for intermittent particle delivery. One possible solution was the use of a gravure like applicator; however, gravure applicators are most commonly known for gravure printing which involves liquids, not particles. In the gravure printing process, an image is recessed into the surface of a metal cylinder. These recesses are very small microcavities which accommodate ink. The ink is most often put into a basin which is contacted by the cylinder to pick up the ink, where the ink is then transferred onto a substrate by pressing the cylinder to the substrate. The dimensions of the cavities and the contact between the ink gravure and the substrate are designed such that the predominate forces that dictate mass transfer are surface tension/capillary/compressive forces. In addition, gravure printing is very dependent on ink viscosity, substrate speed, and the pressure applied between the gravure applicator and the substrate to facilitate the gravure printing process. As particles cannot be applied for the present application in the same fashion, a direct application of a gravure type applicator was not possible and the traditional gravure process needed major adaptations to be able to accomplish the desired manufacturing.

First, to accommodate the delivery of particles from a gravure like applicator, the scale is adapted. Microcavities are removed and larger pockets are included on the applicator (i.e. discretizing element). The use of the larger pockets allows for the accommodation of both smaller and larger particles and at the levels desired for addition to a non-fibrous substrate. In addition, it is desired for there to be flexibility to dynamically change the amount of material dosed using a fixed pocket on a discretizing element. Unlike a traditional gravure rotor which is almost always locked to the desired image to be printed, the use of oversized pockets on a discretizing element allows for the use of inserts to adjust the dosing amount of the particles as desired without the need to replace the entire discretizing element. The oversized pockets also allow for an air gap which would be undesirable in a printing application.

In addition, physical contact between the gravure applicator and the target substrate needs to be removed because contact between the discretizing element and the substrate could damage the substrate. Without physical contact between the discretizing element and the substrate, a different process for transfer of the particles to the substrate is needed than that used in a traditional gravure process. The primary avenue for transfer of particles from a discretizing element and a substrate can be gravity with a proper set-up.

To facilitate the use of gravity, versus compressive forces, to deposit particles from the discretizing element to a substrate, a stationary part, like a stator can be utilized. While a stator is unnecessary for a traditional gravure process, here a stator can help in many ways. For example, a stator can be utilized to help direct the ingress of particles into the discretizing element and egress of particles out of the discretizing element. In addition, the location of the stator inlet can be optimized to help minimize the amount of particles entering an annular space between a stator and a discretizing element. Moreover, the location of the stator output can impact how the particles are deposited onto the substrate and the footprint of those particles on the substrate. The use of a stator is a large departure from a traditional gravure printing process.

As can be seen from the description above, while generally utilizing the idea of a gravure process the present inventors have made significant changes to accommodate such a system for use with particles and in a non-contact environment. Manufacturing Process

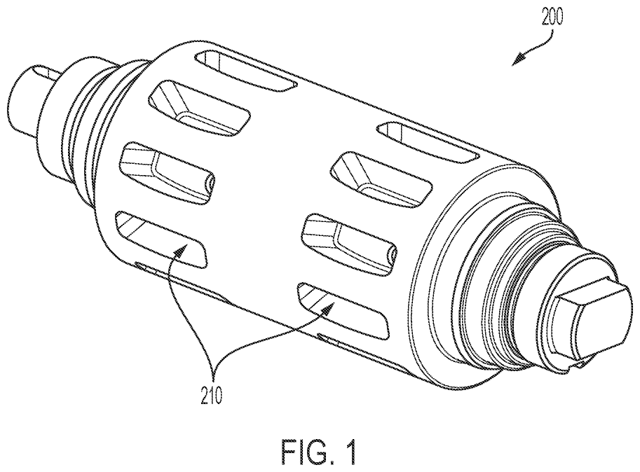

As discussed above, a process for manufacturing a substrate with particles can have two primary elements, a discretizing element 200 and a stator 300. A discretizing element 200 can help take a flow of particles and transform it into discrete units of particles. An example of a discretizing element 200 can be seen in FIG. 1. The discretizing element 200 can then deliver these discretized particle units to a substrate. This function can be accomplished, for example, by including pockets 210 on the discretizing element 200 for receiving particles.

The discretizing element 200 can have one or more pockets 210. The pockets may be fixed with respect to the discretizing element, i.e. they do not move separate from the discretizing element. The number of pockets 210 can be optimized based on the desired and/or operable size of the discretizing element 200. They can also be optimized based on the desired delivery of particles on a substrate. For example, pockets can be side-by-side or top-to-bottom to allow for the delivery of multiple particle loads at the same time. These particle loads may be the same particles or different. A discretizing element can include, for example, from about 1 to about 20 pockets, from about 2 to about 20 pockets, from about 3 to about 20 pockets, from about 5 to about 18 pockets, from about 6 to about 16, from about 8 to about 16, from about 8 to about 12, or any combination thereof.

The location of pockets 210 of the discretizing element 200 can be, for example, equidistant around the circumference of the discretizing element. Equidistant location of pockets on a discretizing element is preferred if operating at a fixed velocity as non-equidistant location of pockets can result in cyclic and/or non-constant motion profile for the discretizing element which can be difficult to control and tune a high operational speeds. They can also cause issues of timing for ingress and/or egress of particles from a pocket.

The pockets 210 on the discretizing clement 200 can be sized as needed for the desired dose. This can include dimensions in the cross direction, machine direction, and depth. The cross direction aligns with the axis of rotation of the discretizing element. For the cross direction, this can contribute to the width of the particle footprint as they are placed on the substrate. The wider the pocket in the cross direction, the wider the footprint of the particles on the substrate. The cross direction dimension can also impact particle ingress and egress from the pocket. A larger dimension in the cross direction can allow for a quicker egress of particles onto the substrate and ingress of particles into the pocket. These can be important parameters to consider when putting together a particle delivery system. The desired cross direction dimension of a pocket can be, for example, from about 1 mm to about 100 mm, from about 3 mm to about 95 mm, from about 10 mm to about 90 mm, from about 20 to about 50 mm, from about 25 mm to about 40 mm, or any combination thereof.

The machine direction is perpendicular to the cross direction. The dimension of a pocket in the machine direction can also contribute to the footprint of the particles on the substrate. The longer the machine direction dimension, the longer the potential footprint of the particle on the substrate. Thus, the machine direction dimension can be limited based on the desired particle footprint. The machine direction dimension can also impact ingress to and egress of the particles from the pocket. The desired machine direction dimension of a pocket can be, for example, from about 1 mm to about 100 mm, from about 3 mm to about 95 mm, from about 10 mm to about 90 mm, from about 20 to about 50 mm, from about 25 mm to about 40, from about 10 mm to about 15 mm, from about 8 mm to about 12 mm, or any combination thereof.

There is an additional consideration for a machine direction dimension. The machine direction dimension in combination with the stator inlet size helps dictate the exposure time of the pocket to the infeed of particles. For a given discretizing unit rotational speed, an increase in the machine direction dimension will allow a pocket ‘more time to fill’ with particles. So, it's a balance of a machine direction dimension that's long enough to appropriately fill with particles, and one that's small enough not to contribute to unnecessarily long dosing times.

The pocket will also have a depth. The depth can be optimized to allow for particle ingress and egress. The depth of a pocket can also be optimized to account for ingress of particle and egress of air from the pocket. A minimum depth is preferred where the particles can retreat into the pocket which minimizes sheering of particles on the stator. For example, a pocket may have a depth of about 1 to about 25 mm, preferably from about 2 to about 15 mm, or from about 3 to about 10 mm. Shecring of particles can cause hygiene issues in the system and cause malfunction over time.

The pocket can also have a shape. The shape can be any that meets the need of the desired particle delivery. For example, the pocket may be a rectangular prism, cube, cone, pyramid, a concave “v”, divots, cylindrical, have a triangular cross section, a rectangular cross section, or any combination thereof. For example, a grid of dimples can be a repeating pattern on the circumference of a discretizing element. In this pattern, a 5×5 grid, for example, could be a unit dose and take the place of a single pocket per unit dose. Where the pocket is a dimple, the number of pockets on can be much higher than discussed above, for example, on the order of 100′s to 1000′s of dimples. For an elongated particle, like a prill, a preferred shape can be a concave v. In addition, the interior of a pocket can be textured.

The discretizing element 200 can also have the function of a metering device. In this configuration, the pockets 210 or a collection of pockets utilized together to make a unit dose on the discretizing element 200 are of the precise volume of the target dose of the particles. If the discretizing element 200 is not also metering, then the pockets 210 will likely be oversized for the target dose and a separate metering device, like a loss-in-weight feeder, can be utilized to meter the flow of particles into the pockets 210 of a discretizing element 200. The target dose of a discretizing element pocket may be by weight or by volume. Utilizing volume can be more accurate as the density of particles can vary from one particle to another. The target dose in weight can be, for example, from about 0.1 g to about 15 g; from about 0.2 g to about 15 g, from about 0.3 g to about 10 g, from about 0.4 g to about 8 g, from about 0.1 g to about 4.0 g. A target dose in terms of volume could be, for example, from about 0.1 cm³ to about 8 cm³, from about 0.1 cm³ to about 7 cm³, from about 0.1 cm³ to about 6 cm³, from about 0.1 cm³ to about 5 cm³, and from about 0.1 cm³ to about 4.0 cm^{3,} or any combination thereof.

A discretizing element is moveable, preferably it rotates. A discretizing element may rotate, for example, at a speed of about 10 rpm to about 100 rpm. The discretizing element 200 can be a rotor. A rotor can be generally described as a rotating assembly. It is generally a driven element, controlled by a motor. The rotor can be run at a desired speed. The speed may be uniform or variable. The speed contributes to the dwell time of a pocket during which the particles ingress into a pocket. When utilizing a non-uniform speed, the discretizing element may be slowed down to allow for ingress of particles from the stator inlet and then sped up to pass through the portion of the discretizing element without a pocket. Likewise, the discretizing element may be sped up so as to capture less particles at the stator inlet and then slowed down to pass through the portion of the discretizing element without a pocket. The same goes for egress from the pocket of a discretizing element. The discretizing element may be sped up or slowed down at the point of particle exit to accommodate the desired particle footprint on the substrate or help coordinate timing of the dose on the substrate.

The rotor can be uniform or non-uniform depending on the desired set-up. A benefit to a fairly uniform rotor is that it allows the process to be run at a set speed to hit a desired unit per minute target. It also allows for better control of the annular space between the discretizing element and the stator. A rotor with varied pocket spacing could also be utilized with the inclusion of a motion profile for the rotational speed.

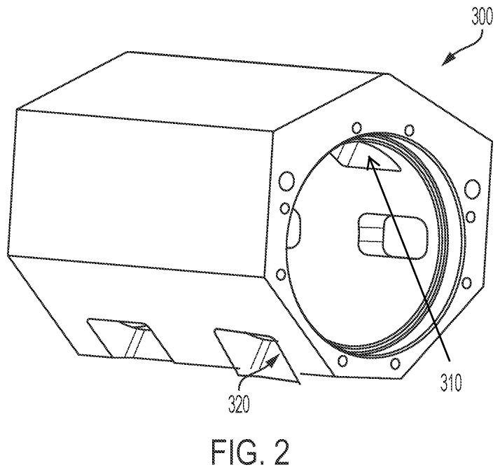

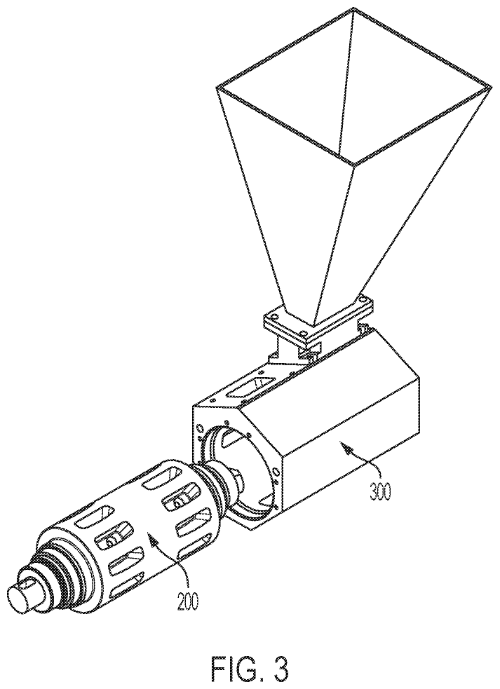

The next element for a particle delivery system can include a stator 300. An example of a stator can be seen in FIG. 2 and an exploded view of a stator 300 and discretizing element 200 in FIG. 3. The stator 300 can include one or more particle inlets 310. The stator 300 can control the flow of particles into the pockets 210 of the discretizing element 200. This can be done, for example, through the design of the particle inlets 310. The dimension, shape, and the location of the inlet 310 on the circumference of the stator 300 can impact filling efficacy of discretizing element pockets 210 with particles. For example, as noted above, increasing the stator inlet opening increases the ability to fill the pockets at higher rotational speeds. For example, by changing the stator inlet opening from 6mm length (direction of rotation) to ˜17 mm, the maximum rate of dosing of a full pocket dose rose from ˜2 doses/s to 8 doses/s without any other changes.

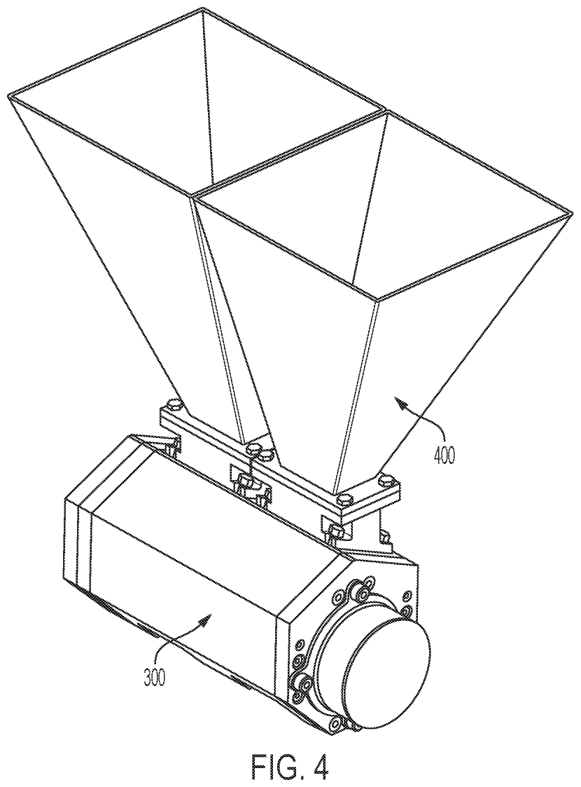

The stator 300 may be a housing for a discretizing element 200 and located around a discretizing element 200, see FIGS. 3 and 4. The location of the stator in relation to the discretizing element also contributes to another parameter—the annular space between the discretizing element and the stator. The specifications and tolerance of this component can ensure minimal particle transfer into this annular space that could then contribute to: particle shearing/breakage, surface fouling, and/or clogging. An additional mechanism may be added to help prevent or minimize particle ingress into the annular space, for example, a mechanical seal or blade could be utilized to prevent particles from getting into the gap between the discretizing element and the stator.

The annular space between a discretizing element and a stator can be adjusted as needed depending on, for example, the size of the particle being deposited on the substrate, machining constraints, cost, and assembly feasibility. The annular space may be, for example, from about 10 μm to about 125 μm, from about 20 μm to about 100 μm, from about 20 μm to about 90 μm, from about 30 μm to about 80 μm, from about 40 μm to about 80 μm, from about 50 μm to about 75 μm, or any combination thereof.

Another way to minimize particles entering the annular space is to minimize the contact between the particles and the annular space. This can be done be positioning the stator inlet so that it is delivering the particles to the discretizing element downhill from the pinch point. The location of the pinch point is determined by the stator inlet wall and the direction of rotation of the discretizing element. A visualization of this concept can be seen in FIG. 6 which shows a cross-section view of a stator and discretizing clement depositing particles on a substrate 700. The pinch point is shown on the left representation and the right representation shows how moving the stator inlet to a downhill position minimizes impact of the particles with the pinch point (i.e. annular space). This minimization helps to keep particle integrity intact, which is especially important for particles which deliver a benefit upon rupture, like a perfume microcapsule. It also helps prevent the creation of fines through the shearing process which changes the particle size distribution of the particle being deposited on the substrate.

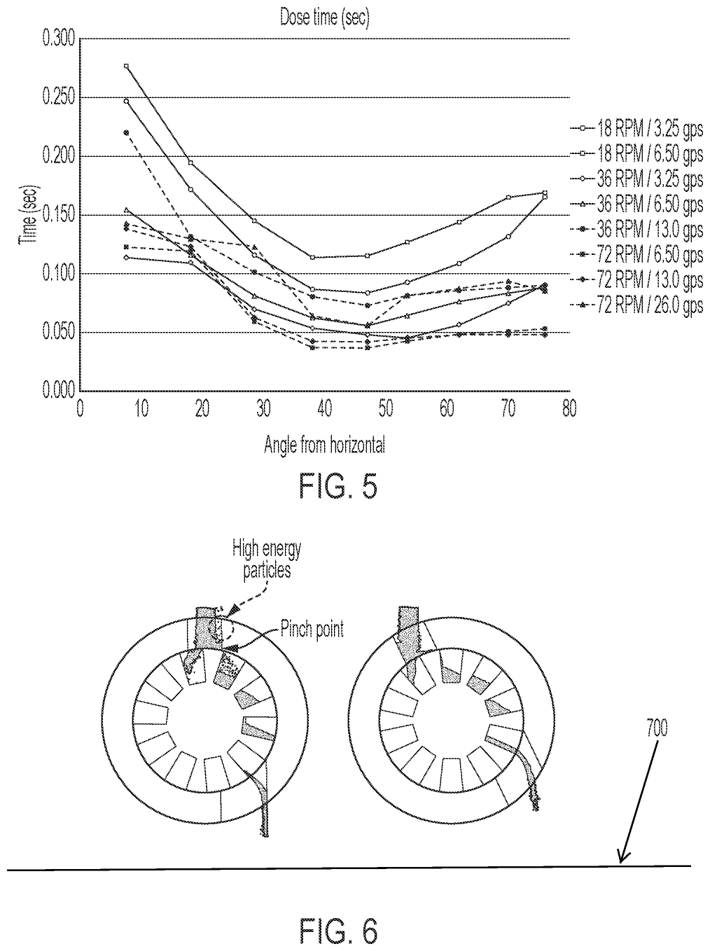

Additional features of a stator 300 can include the dimensions and location along the circumference of the stator of an outlet 320. The outlet design, in combination with the pocket geometry of a discretizing element, can be primary contributors to the laydown of the particles on the substrate. For example, by slight modifications of the design of the stator outlet, the time of particle ejection from the gravure process can be dramatically increased or decreased, which, when coupled with a moving substrate will directly translate to a modification of the laydown footprint of particles onto the substrate. Specifically, a stator opening of about 45 degrees from the horizontal provides an optimum minimum egress time for most particles, as can be seen in FIG. 5. It is also beneficial to design the stator outlet in such a way as the final portion of the particles exiting the stator outlet have a trajectory that is not predominantly downward, but is in the machine direction of the substrate. The net effect is that it decreases the overall particle footprint and gives an economical advantage of being able to speed up the process and to have a better footprint on the substrate.

This discretizing element and stator can be incorporated into a process for making a non-fibrous water soluble product, as described below. Methods of Making a Non-fibrous Water Soluble Product with Particles

A process for making a non-fibrous water soluble product can first include making a non-fibrous water soluble substrate. The substrate may be continuous or discontinuous. A description of a process for making a water soluble non-fibrous substrate can be found, for example, in U.S. Pat. No. 10,683,618, which is incorporated herein by reference.

Once a substrate is formed, it may be provided to the process. A single substrate may be provided, multiple substrates, or even a parent substrate that is cut into multiple substrates during the manufacturing process. Whether starting with a parent substrate which is separated into two substrates, a single substrate, or multiple separate substrates, particles can be added to a substrate utilizing a discretizing element 200 and a stator 300. Particles are supplied to a hopper 400 where they are fed into a stator 300. At least a portion of the particles pass through a stator inlet 310 into a discretizing element pocket 210. The discretizing element pocket 210 may be fully or partially filled with the particles. The discretizing element pocket may be sized to meter the dose. In this execution, the discretizing element pocket dimensions determine the volume of the dose. This dose volume can be altered by, for example, changing out the discretizing element to one with pockets of a different size or, for example, by adding pocket inserts to adjust the volume as desired. The dose can also be metered upstream of the discretizing clement, by, for example, a metering device. In this execution, the discretizing element pockets can be oversized and then filled to the target dose as controlled by the metering device.

A substrate can have a target area for particle application and/or laydown. A target area is that portion of the substrate where particle application is desired. The configuration of the gravure like apparatus can impact the ability of the delivered particles to be applied to and stay within a target area. The gravure like process can allow for deposition of about 75% or more, about 80% or more, about 85% or more, about 90% or more, about 95% or more, or most preferably about 97% or more of delivered particles from a pocket to remain within a target area after exiting a discretizing unit, for example a pocket opening, or until the substrate containing the particles is covered and/or sealed. Multiple pockets may deliver particles to the same target arca of a substrate.

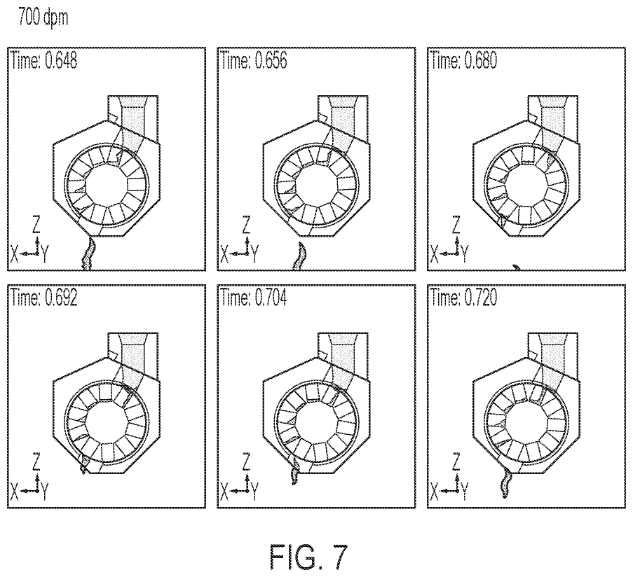

As can be seen in FIGS. 6 and 7, the discretizing element rotates to bring the particles to a stator outlet. The discretizing element may rotate either the same direction as the substrate (preferred) or in the opposite direction of the substrate. The particles leave the discretizing clement pocket, pass through a stator outlet, and are deposited onto the substrate. The substrate may be still or in motion during the deposition process. For example, the substrate may be moving at a rate of about 15 meters per minute or more, about 20 meters per minute or more, about 25 meters per minute or more, 30 meters per minute or more, or preferably from about 30 m/min to about 60 m/min. Gravity can help the particles leave the discretizing element pocket and deposit on the substrate located below the discretizing element.

The substrate may be any reasonable distance from the stator outlet. Generally this distance is minimized to reduce particle velocity and, therefore, particle bounce upon contact with the substrate. The distance from the stator outlet to the substrate should not be too close or there could be gouging of the substrate. In one instance, a target distance of about 1 cm from the stator outlet to the substrate surface is used. In addition, air flow through the substrate, a vacuum through the substrate, or an air curtain can be utilized to help contain particle splashing or movement upon contact with the substrate. Further, a substrate may be at least partially coated with a material to help particles stick to a substrate and/or to minimize particle bounce upon application to a substrate. This can include any material which would make the substrate itself sticky, like water or any material which will partially wet the particles making the particles themselves sticky. These materials could be, for example, other liquid actives, like perfume, silicone (ex. antifoam), etc. This substance could also be, for example, an adhesive. Suitable adhesives can be found in “Viscoelastic Windows of Pressure-Sensitive Adhesives”, E. P. Chang, J. Adhesion 34 (1991) 189-200. These materials can be applied to the substrate, for example, through atomization. This can be in a pattern or random.

Once the particles are positioned on the substrate, a second portion of the substrate or a second substrate is positioned over the first substrate onto which the particles have been deposited. Once the one or more substrates are positioned as desired, they can be bonded to one another, for example, by thermal bonding. Thermal bonding can be practical if one or more of the layers contain a thermoplastic powder, optionally water soluble thermoplastic material.

Thermal bonding can also be practical if the fibers constituting one or more of the substrates are thermoplastic. Substrates can optionally be calendar bonded, point bonded, ultrasonically bonded, infrared bonded, through air bonded, needle punched, hydroentangled, melt bonded, adhesive bonded, cold press, or any other known technical approach for bonding layers of material.

The water soluble products 5 can be separated from one another by a die cutter 160, optionally a rotary die cutter 160. A rotary die cutter 160 comprises a die roll and an anvil roll, the die roll and anvil rotating counter to one another.

The substrates can be bonded to one another and die cut in a single step using a reciprocating bonding and die cutting apparatus or a single rotary bonding and die cutting apparatus. In a rotary bonding and die cutting apparatus that combines the bonding and die cutting, the die is shaped to provide a die cut in which the material being cut is pinched between the knife-edge of the die and the smooth surface of the anvil. Further the die is shaped to compress portions of the product, or continuous substrates, and layers thereof together to bond them to one another. The die can be a patterned die that provides a cutting and bonding pattern to the plies, continuous ply substrates, and layers thereof. Optionally, the die can be heated, which might be practical for thermal bonding.

To be economically feasible, the manufacturing process can have a target minimum number of non-fibrous water soluble products per second. This may be, for example, about 6 water soluble product doses per second. The manufacturing process may have a target of about 100 to about 1000 doses per minute per lanc.

### Non-fibrous Water Soluble Product

A non-fibrous water soluble product can comprise a water soluble non-fibrous substrate. A substrate may be continuous or discrete as shown in FIGS. 1 and 2. The non-fibrous water soluble substrate can be utilized in the formation of a non-fibrous water soluble product which is discussed in more detail below.

A non-fibrous water soluble product can include one or more layers. These layers may be superposed upon one another. The layers may lay directly upon one another, have particles in between the layers, or combination thereof. Layers of a non-fibrous water soluble product can comprise a non-fibrous water soluble substrate, particles, or a combination thereof.

The non-fibrous water-soluble unit dose article may comprise of 50% or greater of bio-based materials, such as for example between 50% and 95% bio-based. Some of the individual components of the non-fibrous water-soluble unit dose article may be fully bio-based to create an article that has a total bio-based content of greater than 50%.

These non-fibrous water-soluble unit dose articles can be dissolved under various wash conditions, e.g., low temperature, low water and/or short wash cycles or cycles where consumers have been overloading the machine, especially with items having high water absorption capacities, while providing sufficient delivery of active agents for the intended effect on the target consumer substrates (with similar performance as today's liquid products).

The surface of the non-fibrous water-soluble unit dose article may comprise a printed area. The printed area may cover between about 10% and about 100% of the surface of the article. The area of print may comprise inks, pigments, dyes, bluing agents or mixtures thereof. The area of print may be opaque, translucent or transparent. The area of print may comprise a single color or multiple colors. The printed area maybe on more than one side of the article and contain instructional text, graphics, etc .. The surface of the water-soluble unit dose article may comprise an aversive agent, for example a bittering agent. Suitable bittering agents include, but are not limited to, naringin, sucrose octacetate, quinine hydrochloride, denatonium benzoate, or mixtures thereof. Any suitable level of aversive agent may be used. Suitable levels include, but are not limited to, 1 to 5000 ppm, or even 100 to 2500 ppm, or even 250 to 2000 ppm.

The non-fibrous water-soluble unit dose articles may exhibit a thickness, for example, of greater than 0.01 mm and/or greater than 0.05 mm and/or greater than 0.1 mm and/or to about 100 mm and/or to about 50 mm and/or to about 20 mm and/or to about 10 mm and/or to about 5 mm and/or to about 2 mm and/or to about 0.5 mm and/or to about 0.3 mm.

The non-fibrous water-soluble unit dose articles may have basis weights of from about 500 grams/m² to about 5,000 grams/m², or from about 1,000 grams/m² to about 4,000 grams/m², or from about 1,500 grams/m² to about 3,500 grams/m², or from about 2,000 grams/m² to about 3,000 grams/m², or any combination thereof.

The non-fibrous water-soluble unit dose article may exhibit different regions, such as different regions of basis weight, density, caliper, and/or wetting characteristics. The non-fibrous water-soluble unit dose article may be compressed at the point of edge sealing. The non-fibrous water-soluble unit dose article may comprise texture on one or more of its surfaces. A surface of the non-fibrous water-soluble unit dose article may comprise a pattern, such as a non-random, repeating pattern. The non-fibrous water-soluble unit dose article may comprise apertures. The non-fibrous water-soluble unit dose article may comprise a non-fibrous structure having discrete regions of non-fibrous elements that differ from other regions of non-fibrous elements in the structure. The non-fibrous water-soluble unit dose article may be used as is or it may be coated with one or more active agents.

The non-fibrous water-soluble unit dose article may comprise one or more plies. The non-fibrous water-soluble unit dose article may comprise at least two and/or at least three and/or at least four and/or at least five plies. The non-fibrous plies can be non-fibrous structures. Each ply may comprise one or more layers, for example one or more non-fibrous element layers, one or more particle layers, and/or one or more non-fibrous element/particle mixture layers. The layer(s) may be sealed. In particular, particle layers and non-fibrous element/particle mixture layers may be sealed, such that the particles do not leak out. The water-soluble unit dose articles may comprise multiple plies, where cach ply comprises two layers, where one layer is a non-fibrous element layer and one layer is a non-fibrous element/particle mixture layer, and where the multiple plies are sealed (e.g., at the edges) together. Sealing may inhibit the leakage of particles as well as help the unit dose article maintain its original structure. However, upon addition of the water-soluble unit dose article to water, the unit dose article dissolves and releases the particles into the wash liquor.

The non-fibrous water-soluble unit dose may be in the form of any three-dimensional structure. The non-fibrous water-soluble unit dose article can be perforated. The article can also be cut or shaped into various sizes for different intended uses. For example, the water-soluble unit dose may be in the form of a square, a rounded square, a kite, a rectangle, a triangle, a circle, an ellipse, and mixtures thereof.

The non-fibrous water-soluble unit dose may comprise less than 10 ingredients. The water-soluble unit dose may comprise between 3 and 9 ingredients, such as, for example, 4 ingredients, 5 ingredients, 6 ingredients, 7 ingredients, or 8 ingredients.

The non-fibrous water-soluble unit dose articles disclosed herein comprise a water-soluble non-fibrous substrate and one or more particles. The non-fibrous substrate may be, for example, a water-soluble film, a foam, a non-woven, or a combination thereof.

The non-fibrous substrate may be a dissolvable foam sheet and may comprise polyvinyl alcohol (PVA) polymer or copolymer thereof as a film-former, a structurant as well as a carrier for any other optional ingredients, like surfactant(s) and other active ingredients (c.g., emulsifiers, builders, chelants, perfumes, colorants, and the like). It is preferred the PVA polymer or copolymer is present in the non-fibrous foam substrate in an amount ranging from about 5% to about 50%, preferably from about 10% to about 40%, preferably from about 15% to about 30%, more preferably from about 20% to about 25%, by total weight of the non-fibrous foam substrate, most preferably the total amount of PVA(s) present in the non-fibrous substrate is no more than 25% by total weight of the substrate.

PVA polymers or copolymers suitable herein are selected those with weight average molecular weights ranging from about 50,000 to about 400,000 Daltons, preferably from about 60,000 to about 300,000 Daltons, more preferably from about 70,000 to about 200,000 Daltons, most preferably from about 80,000 to about 150,000 Daltons. The weight average molecular weight is computed by summing the average molecular weights of each polymer raw material multiplied by their respective relative weight percentages by weight of the total weight of polymers present within the porous solid.

The non-fibrous foam substrate is preferably made by first forming a wet pre-mixture containing the PVA, any surfactant(s) and other optional ingredients, followed by shaping the wet pre-mixture into a sheet and then drying such sheet of wet pre-mixture to form a solidified non-fibrous substrate. Correspondingly, the weight average molecular weight of the PVA polymer or copolymer may affect the overall film-forming properties of the wet pre-mixture and its compatibility/incompatibility with any desired additional ingredients. Further, the weight average molecular weight of the PVA polymer or copolymer used herein may impact the viscosity of the wet pre-mixture, which may in turn influence various physical properties of the resulting non-fibrous substrate so formed.

The PVA polymer or copolymer may further be characterized by a degree of hydrolysis ranging from about 40% to about 100%, preferably from about 50% to about 95%, more preferably from about 70% to about 92%, most preferably from about 80% to about 90%.

The PVA copolymer may include a vinyl alcohol monomer and one or more monomers of any other type. Preferred PVA copolymers can include, in addition to the vinyl alcohol monomer and one or more anionic monomers represented by Formula (I) and/or (II) at below:

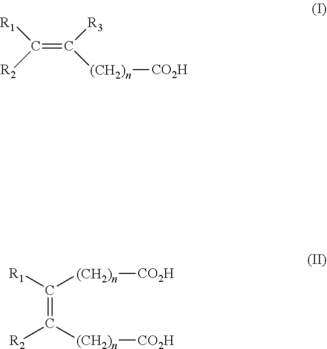

wherein R₁, R₂ and R₃ are each independently H or methyl, and n is independently an integer of 0 to 3. The above-described anionic monomeric unit, if present, is preferably present in an amount ranging from about 0.5 to about 5 mol %.

Commercially available polyvinyl alcohols include those from Celanese Corporation (Texas, USA) under the CELVOL trade name including, but not limited to, CELVOL 523,

CELVOL 530, CELVOL 540, CELVOL 518, CELVOL 513, CELVOL 508, CELVOL 504; those from Kuraray Europe GmbH (Frankfurt, Germany) under the Mowiol® and POVAL™M trade names; and PVA 1788 (also referred to as PVA BP17) commercially available from various suppliers including Lubon Vinylon Co. (Nanjing, China); and combinations thereof. In one example, the nonfibrous substrate comprises from about 10% to about 25%, more preferably from about 15% to about 23%, by total weight of such article, of a polyvinyl alcohol having a weight average molecular weight ranging from 80,000 to about 150,000 Daltons and a degree of hydrolysis ranging from about 80% to about 90%.

In addition to PVAs as mentioned hereinabove, a single starch or a combination of starches may be used as a filler material in such an amount as to reduce the overall level of PVAs required, so long as it helps provide non-fibrous substrate with the requisite structure and physical/chemical characteristics as described herein. However, too much starch may comprise the solubility and structural integrity of the non-fibrous article. Therefore, it is preferred the non- fibrous substrate comprises no more than 20%, preferably from 0% to 10%, more preferably from 0% to 5%, most preferably from 0% to 1%, by weight of said solid sheet article, of starch.

A non-fibrous substrate may be a film. Preferred film materials are polymeric materials. The film material can be obtained, for example, by casting, blow-molding, extrusion or blown extrusion of the polymeric material, as known in the art. Preferred polymers, copolymers or derivatives thereof suitable for use herein can comprise polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatin, natural gums such as xanthan and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), or a combination thereof.

Preferably, the level of polymer in the film, for example a PVA polymer, is at least 60%. The polymer can have any weight average molecular weight, preferably from about 1000 to 1,000,000, more preferably from about 10,000 to 300,000 yet more preferably from about 20,000 to 150,000. Mixtures of polymers can also be used as the film. This can be beneficial to control the mechanical and/or dissolution properties of the compartments or film, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000.

Also, suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material.

Naturally, different film material and/or films of different thickness may be employed herein. A benefit in selecting different films is that the resulting products and/or compartments may exhibit different solubility or release characteristics.

Most preferred film materials are PVA films known under the MonoSol trade reference M8630, M8900, H8779 and those described in U.S. Pat. No. 6,166,117 and US 6,787,512 and PVA films of corresponding solubility and deformability characteristics, incorporated herein by reference. The film material herein can also comprise one or more additive ingredients. For example, it can be beneficial to add plasticizers, for example glycerol, ethylene glycol, diethyleneglycol, propylene glycol, sorbitol and mixtures thereof. Other additives include functional detergent additives to be delivered to the wash water, for example organic polymeric dispersants, etc.

### Particles

Particles may be incorporated into a non-fibrous water soluble product as discussed above, at a level of about 0.1 g to about 30 g, for example. The type of particles utilized can be any that are compatible with the manufacturing system. One parameter which can contribute to the success of depositing particles according to this method is the flowability of the particles. The flowability (fₚ) of particles can be defined as the ratio of consolidation stress (cs) to unconfined yield strength (ys). The larger the fₚ, the better particles flow. Generally, it is believed that an fₚ<1 is not flowing, an fₚ>1 but less than 2 is very cohesive, an fₚof 2 to less than 4 is considered cohesive, an fₚof 4 to less than 10 is considered easy flowing, and an fₚof 10 or more is considered free flowing. For the process described above, particles with an fₚvalue of about 4 or more are preferred. The level of flowability can be determined by the Flowability Method listed below. Flowability of the particles may be for example, about 1 or more, about 2 or more, about 3 or more, about 4 or more, about 5 or more, about 5 or more, about 6 or more, about 7 or more, about 8 or more, about 9 or more, about 10 or more, to about 1000 or less.

The particles may be a powder, granule, agglomerate, encapsulate, microcapsule, and/or prill. The particles may be made using a number of well-known methods in the art, such as spray-drying, agglomeration, extrusion, prilling, encapsulation, pastillation, and combinations thereof. The shape of the particles can be in the form of spheres, rods, plates, tubes, squares, rectangles, discs, stars, fibers or have regular or irregular random forms. The particles may have a D50 particle size of from about 100 μm to about 1600 μm.

The particles may include a mixture of chemically different particles, such as: surfactant particles, including surfactant agglomerates, surfactant extrudates, surfactant needles, surfactant noodles, surfactant flakes; phosphate particles; zeolite particles; silicate salt particles, especially sodium silicate particles; carbonate salt particles, especially sodium carbonate particles; polymer particles such as carboxylate polymer particles, cellulosic polymer particles, starch particles, polyester particles, polyamine particles, terephthalate polymer particles, polyethylene glycol particles; aesthetic particles such as colored noodles, needles, lamellac particles and ring particles; enzyme particles such as protease granulates, amylase granulates, lipase granulates, cellulase granulates, mannanase granulates, pectate lyase granulates, xyloglucanase granulates, bleaching enzyme granulates and co- granulates of any of these enzymes, these enzyme granulates may comprise sodium sulphate; bleach particles, such as percarbonate particles, especially coated percarbonate particles, such as percarbonate coated with carbonate salt, sulphate salt, silicate salt, borosilicate salt, or any combination thereof, perborate particles, bleach activator particles such as tetra acetyl ethylene diamine particles and/or alkyl oxybenzene sulphonate particles, bleach catalyst particles such as transition metal catalyst particles, and/or isoquinolinium bleach catalyst particles, pre-formed peracid particles, especially coated pre-formed peracid particles; filler particles such as sulphate salt particles and chloride particles; clay particles such as montmorillonite particles and particles of clay and silicone; flocculant particles such as polyethylene oxide particles; wax particles such as wax agglomerates; silicone particles, brightener particles; dye transfer inhibition particles; dye fixative particles; perfume particles such as perfume microcapsules and starch encapsulated perfume accord particles, or pro-perfume particles such as Schiff base reaction product particles; hueing dye particles; chelant particles such as chelant agglomerates; and any combination thereof.

### Combinations

1. A method of manufacturing a non-fibrous water soluble product comprising particles, comprising: a) providing a first continuous water soluble non-fibrous substrate comprising a first side and moving in a first direction, b) providing a discretizing unit comprising one or more pockets comprising an opening; c) providing a continuous feed of first particles to at least one of the one or more pockets of the discretizing unit through the pocket opening at least partially filling the at least one of the one or more pockets, d) delivering the first particles from the pocket through the opening onto a portion of the first side of the first continuous water soluble non-fibrous substrate, and e) at least partially covering the first side of the first continuous water soluble non-fibrous substrate.

2. A method of manufacturing a non-fibrous water soluble product comprising particles, comprising: a) providing a first continuous water soluble non-fibrous substrate comprising a first side and moving in a first direction, b) providing a discretizing unit comprising one or more pockets comprising an opening; c) providing a continuous feed of first particles to at least one of the one or more pockets of the discretizing unit through the pocket opening, d) intermittently delivering the first particles from the pocket opening onto a portion of a first side of the first continuous water soluble non-fibrous substrate, e) metering the first particles to a target dose, and f) at least partially covering the first side of the first continuous water soluble non-fibrous substrate.

3.The method of any one of 1 or 2, further comprising sealing the first continuous water soluble non-fibrous substrate and the covering entrapping at least a portion of the first particles between the first water soluble substrate and the covering, wherein the covering comprises a second non-fibrous water soluble substrate.

4. The method of 3, wherein sealing the first continuous water soluble non-fibrous substrate to the second continuous water soluble non-fibrous substrate entrapping at least a portion of the particles forms a unit dose.

5. The method of any of 1-4, wherein the first particles are delivered to a target area on the first side of the first continuous water soluble substrate and at least 75%, about 80% or more, about 85% or more, about 90% or more, about 95% or more, or most preferably about 97% or more, of the first particles stay on the target area upon exiting the discretizing unit.

6. The method of any of 1-5, wherein the discretizing unit comprises a rotor.

7. The method of 6, wherein the rotor comprises the one or more pockets and the particles are contained in at least one of the one or more pockets of the rotor prior to being delivered onto a portion of the first side of the first continuous substrate.

8. The method of any one of 1-7, wherein a size of the pocket meters the amount of the first particles to be delivered to the portion of the first side of the first continuous substrate.

9. The method of any one of 1-8, wherein the first continuous water soluble non-fibrous substrate is moving in the first direction at about a speed of about 5 m/min to about 100 m/min.

10. The method of any one of 1-9, wherein the first particles are delivered intermittently from the one or more pockets of the discretizing unit.

11. The method of any one of 1-10, wherein the particles have a flowability of about 4 or more, preferably from about 4 to about 1000.

12. The method of any one of 1-11, wherein the particles are delivered from the discretizing unit into an area of about 20 mm² to about 6000 mm² of the first continuous substrate to form a unit dose, wherein one or more unit doses may be formed on the first continuous substrate.

13. The method of any one of 1-12, wherein the discretizing unit discretizes the continuous flow of the first particles into one or more individual doses.

14. The method of any one of 1-13, further comprising: a) providing a third continuous water soluble non-fibrous substrate moving having a first side and a second side in the first direction, b) providing a feed of second particles to a second discretizing unit, c) delivering the second particles from the discretizing unit onto a portion of the second side of the second continuous water soluble substrate; d) placing the first side of the third continuous substrate over the second particles.

15. The method of any one of 1-14, further comprising providing a feed of second particles to the discretizing unit, wherein the first particles and the second particles are the same or different.

16. The method of any one of 1-15, wherein the discretizing unit moves at a constant speed.

17. The method of any one of 1-16, wherein the discretizing unit moves at a variable speed.

18. The method of any one of 1-17, wherein at least one pocket of the discretizing unit travels in sync with the first continuous water soluble non-fibrous substrate during deposition of the particles onto the first continuous water soluble non-fibrous substrate.

19. The method of any one of 1-18, wherein the particles comprise powder, granule, agglomerate, encapsulate, microcapsule, prill, or a combination thereof.

20. The method of any one of 1-19, wherein the first particles have a flowability of about 4 or more.

21. A particle applicator apparatus, comprising:
a stator comprising an inlet and an outlet; and
a rotating discretizing unit for receiving and delivering particles comprising one or more pockets, dimples, or a combination thereof;
5 wherein the stator and rotating discretizing unit are operably connected.

22. The particle applicator apparatus of 21, wherein the rotating discretizing unit rotates at a variable speed.

23. The particle applicator apparatus of any one of 21-22, wherein the rotating discretizing unit comprises pockets, preferably pockets which are equidistantly spaced.

24. The particle applicator apparatus of any one of 21-23, wherein the rotating discretizing unit comprises from about 1 to about 20 pockets, from about 2 to about 20 pockets, from about 3 to about 20 pockets, from about 5 to about 18 pockets, from about 6 to about 16 pockets, from about 8 to about 16 pockets, or from about 8 to about 12 pockets.

25. The particle applicator apparatus of any one of 21-24, wherein the rotating discretizing unit comprises pockets having a cross direction dimension of from about 1 mm to about 100 mm, from about 3 mm to about 95 mm, from about 10 mm to about 90 mm, from about 20 to about 50 mm, or from about 25 mm to about 40 mm.

26. The particle applicator apparatus of any one of 21-25, wherein the rotating discretizing unit comprises pockets having a machine direction dimension of from about 1 mm to about 100 mm, from about 3 mm to about 95 mm, from about 10 mm to about 90 mm, from about 20 to about 50 mm, from about 25 mm to about 40, from about 10 mm to about 15 mm, or from about 8 mm to about 12 mm.

27. The particle applicator apparatus of any one of 21-26, wherein the rotating discretizing unit comprises pockets having a depth of from about 1 mm to about 100 mm, from about 3 mm to about 95 mm, from about 10 mm to about 90 mm, from about 20 to about 50 mm, from about 25 mm to about 40, from about 10 mm to about 15 mm, or from about 8 mm to about 12 mm.

28. The particle applicator apparatus of any one of 21-27, wherein the rotating discretizing unit comprises pockets having a shape of a rectangular prism, cube, cone, pyramid, a concave “v”, divots, cylindrical, any shape with a triangular cross section, any shape with a rectangular cross section, or any combination thereof.

29. The particle applicator apparatus of any one of 21-28, wherein the discretizing unit meters a target dose of particles.

30. The particle applicator apparatus of any one of 21-29, wherein the rotating discretizing unit comprises pockets and the pockets are the volume of a target dose of particles.

31. The particle applicator apparatus of any one of 21-30, wherein a target dose of particles for the rotating discretizing unit is from about 0.1 g to about 15 g; from about 0.2 g to about 15 g, from about 0.3 g to about 10 g, from about 0.4 g to about 8 g, from about 0.1 g to about 4.0 g. A target dose in terms of volume could be, for example, from about 0.1 cm³ to about 8 cm³, from about 0.1 cm³ to about 7 cm³, from about 0.1 cm³ to about 6 cm³, from about 0.1 cm³ to about 5 cm³, and from about 0.1 cm³ to about 4.0 cm³, or any combination thereof.

32. The particle applicator apparatus of any one of 21-31, wherein the rotating discretizing unit comprises a rotor.

33. The particle applicator apparatus of any one of 21-32, wherein the stator comprising a housing.

34. The particle applicator apparatus of 33, wherein the rotating discretizing unit is located at least partially inside of the stator housing.

35. The particle applicator apparatus of 34, wherein there is an annular space between the stator housing and the rotating discretizing unit.

36. The particle applicator apparatus of 35, wherein the annular space is from about 10 μm to about 125 μm, from about 20 μm to about 100 μm, from about 20 μm to about 90 μm, from about 30 μm to about 80 μm, from about 40 μm to about 80 μm, from about 50 μm to about 75 μm, or any combination thereof.

37. The particle applicator of any 21-36, wherein the stator inlet is positioned so that the rotating discretizing unit receives particles when the portion of the rotating discretizing unit receiving particles is heading in a downward trajectory.

38. The particle applicator of any of 21-37, wherein the stator outlet is located about 45° from horizontal.

39. The particle applicator of any of 21-38, wherein the particle applicator applies particles to a non-fibrous substrate.

### Flowability Method

The following comparative test is carried out to demonstrate the flowability of particles at ambient temperature and humidity

The device adapted for this test is a commercially available flowability testing system,

FloDex™ (Teledyne Hanson Research, Chatsworth, Calif., USA), which contains a flat bottom cylindrical hopper with a removable bottom and a set of interchangeable bottom disks containing therein orifices of different sizes. Further, additional bottom disks with orifices of smaller sizes (with diameters below 4 mm) are made so as to provide a more complete range of orifice diameters including 3 mm, 3 mm, 4 mm, 5 mm, 6 mm, 7 mm, 8 mm, 9 mm, 10 mm, 12 mm, 14 mm, 16 mm, 18 mm until 34 mm.

The FloDex™ equipment includes a funnel for loading a particulate test sample into a stainless-steel flat-bottom cylindrical hopper having a diameter of about 5.7 cm. The hopper has a removable bottom defined by a removal bottom disk with an orifice of a specific size therein. Multiple removal bottom disks having orifices of different sizes are provided, as mentioned hereinabove, which can be interchangeably fit at the bottom of hopper in place of disk to thereby define a bottom orifice of a different size. A discharge gate is placed immediately underneath the orifice and above a receiver. When the flowability measurement starts, the discharge gate is moved so as to expose the bottom orifice and allow the particulate test sample to flow from the hopper through the bottom orifice down to the receiver.

To test the flowability of a specific test sample, the following steps are followed:
a. Fill the hopper by pouring about 75 ml of the test sample through funnel. This corresponds to a roughly 1″ (25 mm) layer of powder in the cylindrical hopper.
b. After the sample settles for 30 seconds, open the spring-loaded discharge gate and allow the sample to flow through the orifice into the receiver.
c. Steps (a) and (b) are repeated for the same test sample using different bottom disks having orifices of gradually increasing orifice sizes. At the beginning when the bottom disks with relatively smaller orifices are used, the flow of the test sample typically stops at some point due to jamming, i.e., it cannot pass through the orifice due to the small orifice size. Once the flow of test sample stops, a jam is declared, and the specific bottom disk causing the jam is removed and replaced by another bottom disk with an orifice that is slightly larger for another repeat of steps (a) and (b). When the test sample is able to flow completely through an orifice of a specific size for three (3) consecutive times without jamming, such orifice size is recorded as the FloDex™ Blockage Parameter and B refers to the diameter of the orifice in the Flow Disk used in the test . The smaller the FloDex™ Blockage Parameter, the better the flowability of the test sample (i.e., it can flow through smaller orifices without jamming).

Flowability is then calculated according to the following equation:

$$ffc = \frac{H ( {θ}^{′} ) \cdot A \cdot ( 1 - {e}^{- \frac{K \cdot tan ( {ϕ}^{′} ) \cdot U \cdot h}{A}} )}{B \cdot K \cdot tan ( {ϕ}^{′} ) \cdot U}$$

, where H(θ′)=(130°-θ′)/65° is the hopper flow function as proposed by Jenike, θ′ is the internal flow-channel angle in the powder, A is the cross-sectional area of the FloDex, U is the perimeter of the FloDex, K is the lateral stress ratio proposed by Janssen, Φ′ is the wall friction coefficient between the powder and the side wall of the steel cylinder, B is the critical diameter of blockage in the FloDex (in units mm), and h is the fill height of powder in the FloDex (in units mm). After inserting the values for FloDex geometry and reasonable values for powder in a flat-bottom steel hopper (K=0.4,θ′=10°, Φ′=20°), the equation simplifies to:

$$ffc = \frac{210.8 \cdot ( 1 - {e}^{- 0.0102 h} )}{B}$$

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of manufacturing a non-fibrous water soluble product comprising particles, comprising:
a) providing a first continuous water soluble non-fibrous substrate comprising a first side and moving in a first direction,
b) providing a discretizing unit comprising one or more pockets comprising an opening;
c) providing a continuous feed of first particles to at least one of the one or more pockets of the discretizing unit through the pocket opening at least partially filling the at least one of the one or more pockets,
d) delivering the first particles from the pocket through the opening onto a portion of the first side of the first continuous water soluble non-fibrous substrate, and
e) at least partially covering the first side of the first continuous water soluble non-fibrous substrate.

2. The method of claim 1, further comprising sealing the first continuous water soluble non-fibrous substrate and the covering entrapping at least a portion of the first particles between the first water soluble substrate and the covering, wherein the covering comprises a second non-fibrous water soluble substrate.

3. The method of claim 2, wherein sealing the first continuous water soluble non-fibrous substrate to the second continuous water soluble non-fibrous substrate entrapping at least a portion of the particles forms a unit dose.

4. The method of claim 1, wherein the first particles are delivered to a target area on the first side of the first continuous water soluble substrate and at least 75% of the first particles stay on the target area upon exiting the discretizing unit.

5. The method of claim 1, wherein the discretizing unit comprises a rotor.

6. The method of claim 5, wherein the rotor comprises the one or more pockets and the particles are contained in at least one of the one or more pockets of the rotor prior to being delivered onto a portion of the first side of the first continuous substrate.

7. The method of claim 6, wherein a size of the pocket meters the amount of the first particles to be delivered to the portion of the first side of the first continuous substrate.

8. The method of claim 1, wherein the first continuous water soluble non-fibrous substrate is moving in the first direction at about a speed of about 5 m/min to about 100 m/min.

9. The method of claim 1, wherein the first particles are delivered intermittently from the one or more pockets of the discretizing unit.

10. The method of claim 1, wherein the particles have a flowability of about 4 or more.

11. The method of claim 1, wherein the particles are delivered from the discretizing unit into an area of about 20 mm² to about 6000 mm² of the first continuous substrate to form a unit dose, wherein one or more unit doses may be formed on the first continuous substrate.

12. The method of claim 1, wherein the discretizing unit discretizes the continuous flow of the first particles into one or more individual doses.

13. The method of claim 1, further comprising:
a) providing a third continuous water soluble non-fibrous substrate moving having a first side and a second side in the first direction,
b) providing a feed of second particles to a second discretizing unit,
c) delivering the second particles from the discretizing unit onto a portion of the second side of the second continuous water soluble substrate;
d) placing the first side of the third continuous substrate over the second particles.

14. The method of claim 1, further comprising providing a feed of second particles to the discretizing unit, wherein the first particles and the second particles are the same or different.

15. The method of claim 1, wherein the discretizing unit moves at a constant speed.

16. The method of claim 1 where the discretizing unit moves at a variable speed.

17. The method of claim 1, wherein at least one pocket of the discretizing unit travels in sync with the first continuous water soluble non-fibrous substrate during deposition of the particles onto the first continuous water soluble non-fibrous substrate.

18. The method of claim 1, wherein the particles comprise powder, granule, agglomerate, encapsulate, microcapsule, prill, or a combination thereof.

19. A method of manufacturing a non-fibrous water soluble product comprising particles, comprising:
a) providing a first continuous water soluble non-fibrous substrate comprising a first side and moving in a first direction,
b) providing a discretizing unit comprising one or more pockets comprising an opening;
c) providing a continuous feed of first particles to at least one of the one or more pockets of the discretizing unit through the pocket opening,
d) intermittently delivering the first particles from the pocket opening onto a portion of a first side of the first continuous water soluble non-fibrous substrate,
e) metering the first particles to a target dose, and
f) at least partially covering the first side of the first continuous water soluble non-fibrous substrate.

20. The method of claim 19, wherein the first particles have a flowability of about 4 or more.
